(19) United States
(12) Patent Application Publication
(10) Pub. No.: US 2017/0015217 A1
(43) Pub. Date: Jan. 19, 2017

(54) DEPLOYABLE SEAT CONTROL INTERFACE MECHANISM

(71) Applicant: JOHNSON CONTROLS TECHNOLOGY COMPANY, Holland, MI (US)

(72) Inventors: Mason PIKE, Howell, MI (US); Anthony Spadaro, Northville, MI (US); Brennon White, Novi, MI (US)

(73) Assignee: JOHNSON CONTROLS TECHNOLOGY COMPANY, Holland, MI (US)

(21) Appl. No.: 15/124,715

(22) PCT Filed: Mar. 12, 2014
(86) PCT No.: PCT/US2014/024505

§ 371 Date: Sep. 9, 2016

(51) Int. Cl. B60N 2/02; B60N 2/16; B60N 2/66; B60N 2/20; B60N 2/06

(52) U.S. Cl. CPC B60N 2/0228; B60N 2/20; B60N 2/06; B60N 2/66; B60N 2/16; B60N 2002/4485

(57) ABSTRACT

A seat control interface mechanism for a vehicle seat may comprise an interface control surface having at least one interface that allows an occupant of the vehicle seat to activate seat controls; and a movable member upon which the interface control surface is located, the moveable member being configured to be displaced relative to the vehicle seat to cause the interface control surface to become more accessible to the occupant of the vehicle seat. A method of operation to adjust an orientation of the vehicle seat may comprise moving an interface control surface relative to the vehicle seat to cause the interface control surface to become more accessible to an occupant of the vehicle seat; and operating at least one touch-sensitive interface on the interface control surface to activate at least one seat control for the vehicle seat.

### FIELD

The present application relates generally to the field of seat control mechanisms for a vehicle. More specifically, the present disclosure relates to a seat control interface mechanism configured to be stowed away when not in use and a method of adjusting the seat orientation.

### BACKGROUND

Currently, seat controls may be used to control seat adjustment mechanisms for setting the position and/or orientation of a vehicle seat. These seat controls may be placed along the outboard side bolster region of the vehicle seat, but in such a case, a narrower vehicle seat is required to allow for enough clearance for seat controls between the seat and the vehicle door. For example, there must be enough room for a large hand to fit between the vehicle seat and the door panel to reach the seat controls.

Further, the seat controls must be visible in order to allow the occupant to effectively operate the seat adjustment mechanisms. However, due to vehicle packaging constraints, such as the vehicle and vehicle seat size constraints, there is not sufficient room to provide readily accessible and visible seat controls. Consequently, it is difficult to reach and/or see the seat controls. This may require the occupant to use trial and error to when using the seat controls due to the lack of visual feedback.

There continues to be a need for a seat control mechanism with seat controls in which the seat control mechanism does not limit the size of the vehicle or vehicle seat, is accessible to the occupant, and/or provides visual feedback to the user.

### SUMMARY

According to one embodiment of the present invention, a seat control interface mechanism for a vehicle seat may comprise: an interface control surface having at least one interface that allows an occupant of the vehicle seat to activate seat controls; and a movable member upon which the interface control surface is located, the moveable member being configured to be displaced relative to the vehicle seat to cause the interface control surface to become more accessible to the occupant of the vehicle seat.

In any of the embodiments, the movable member can be configured to be at least partially retracted toward the vehicle seat into a first position, wherein the interface control surface can be configured to be substantially contained within the vehicle seat when the movable member is in the first position, wherein the movable member can be configured to be at least partially extended away from the vehicle seat into a second position, wherein the interface control surface can be configured to be substantially exposed to an interior of the vehicle when the movable member is in the second position.

In any of the embodiments, the movable member can be configured to be deployed away from a side bolster of the vehicle seat such that the interface control surface is positioned substantially parallel to a seat cushion of the vehicle seat.

In any of the embodiments, the interface control surface can comprise at least one touch-sensitive interface.

In any of the embodiments, the at least one touch-sensitive interface can be configured to activate at least one of a reclining mechanism, a forward-rearward seat sliding mechanism, a seat height adjustment mechanism, a bolster adjustment mechanism, and a lumbar adjustment mechanism.

In any of the embodiments, the at least one touch-sensitive interface can be one of a capacitive control, a piezoelectric control, and a piezoresistive control.

In any of the embodiments, the at least one touch-sensitive interface can be configured to provide haptic feedback to the occupant of the vehicle seat.

In any of the embodiments, the interface control surface can comprise at least one backlit interface.

In any of the embodiments, the movable member can be rotatable between the first position in which the interface control surface can be entirely inside a side bolster of the vehicle seat and the second position in which the interface control surface can be between the side bolster and a vehicle door.

In any of the embodiments, the movable member can be movable between a first position and a second position.

In any of the embodiments, the movable member can be configured to move vertically and laterally from a first position to a second position.

According to another embodiment of the present invention, a method of operation to adjust an orientation of the vehicle seat can comprise moving an interface control surface relative to the vehicle seat to cause the interface control surface to become more accessible to an occupant of the vehicle seat; and operating at least one touch-sensitive interface on the interface control surface to activate at least one seat control for the vehicle seat.

In any of the embodiments, the step of moving the interface control surface can include moving the interface control surface from a first position in which the interface control surface can be substantially contained within the vehicle seat to a second position in which the interface control surface can be substantially exposed to the interior of the vehicle.

In any of the embodiments, the interface control surface can be disposed on a movable member, and moving the interface control surface from the first position to the second exposed position can comprise moving the movable member vertically and laterally from the first position to the second position.

In any of the embodiments, the interface control surface can be disposed on a movable member, and moving the interface control surface from the first position to the second exposed position can comprise pivoting the movable member about a pivot axis.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a perspective view of a vehicle according to one embodiment of the present invention.

FIG. 2 is a perspective view of an embodiment of a vehicle seat that can be disposed in the vehicle of FIG. 1.

FIG. 3 is a perspective view of a seat control interface mechanism in a first position according to one embodiment of the present invention, which can be implemented on the vehicle seat of FIG. 2.

FIG. 4 is a perspective view of the seat control interface mechanism of FIG. 3 in a second position.

FIG. 5 is a top view of the seat control interface mechanism of FIG. 3 in the second position.

FIG. 6 is a side view of the seat control interface mechanism of FIG. 3 in the second position .

FIG. 7 is a perspective view of a seat control interface mechanism according to another embodiment of the present invention in a second position which can be implemented on a vehicle seat.

FIG. 8 is a top view of the seat control interface mechanism of FIG. 7 in a first position.

FIG. 9 is a close-up, top view of the seat control interface mechanism of FIG. 7 in the first position.

FIG. 10 is a top view of the seat control interface mechanism of FIG. 7 in the second position.

### DETAILED DESCRIPTION

Referring generally to the figures, disclosed herein is a seat control interface mechanism, as shown according to exemplary embodiments. The seat control interface mechanism may be used within a vehicle, and, more specifically, with a vehicle seat. The seat control interface mechanism may include a movable member and an interface control surface. The movable member may move between being at least partially retracted relative to the vehicle seat and being at least partially extended out from the vehicle seat. The interface control surface may be located on the movable member and used to control the seat adjustments of the vehicle seat. Various seat controls may be located on the interface control surface.

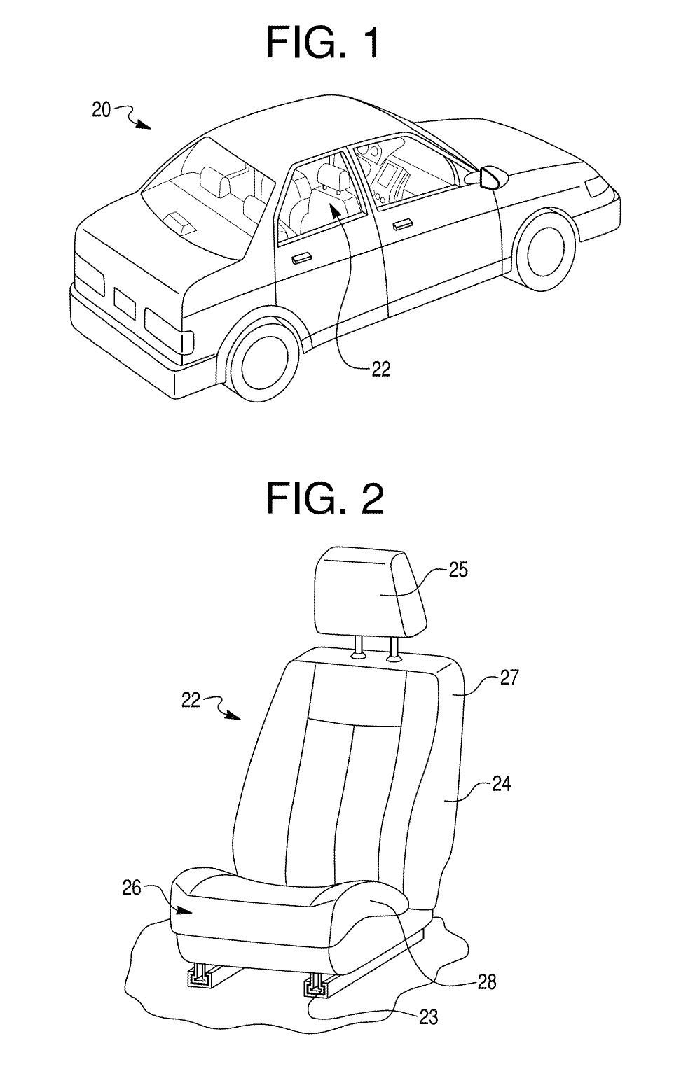

FIG. 1 illustrates a vehicle 20 in which a seat control interface mechanism may be placed in the vehicle 20. The vehicle 20 may include an interior passenger compartment containing a vehicle seat 22 for providing seating to an occupant. Although a four-door sedan is shown in FIG. 1, the seat control interface mechanism may be used in a variety of non-vehicle applications, but are particularly useful within the seats of any type of vehicle, such as a two-door or four-door automobile, a truck, a SUV, a van, a train, a boat, an airplane, or other suitable vehicular conveyance.

According to one embodiment of the present invention, the vehicle seat 22, as depicted in FIG. 2, may be adjusted by the seat control interface mechanism. For example, a seat back 24 may be adjusted relative to a base seat cushion 26 and/or the vehicle seat 22 may be adjusted relative to the vehicle 20. The vehicle seat may be any seat in the vehicle, such as a front or rear driver-side seat and/or a front or rear passenger-side seat and may use conventional motors, gears, etc. Additionally the vehicle seat 22 may refer to or be defined as the entire vehicle seat structure and components or any portion thereof. For example, the vehicle seat 22 may include a variety of components, including but not limited to a head restraint, a seat back, a seat cushion, a seat bottom, an arm rest, a frame, a support shell, and/or bolster regions. The vehicle seat 22 may be defined by any of its various components. For example, the seat control interface mechanism may be moved relative to and/or contained within any component of the entire vehicle seat 22. Alternatively or additionally, the seat control interface mechanism may be located or integrated near the vehicle seat 22, such as within a door or center console.

The overall structure of the vehicle seat 22 including its structural frame, padding, and covering can be any known seat known in the art. For example, the overall structure of the seat may be, for example, any of the vehicle seats disclosed in U.S. Patent Application Publication Nos. 2012/0032486, 2011/0316317, 2011/0260514, 2011/0080026, 2011/0074199, 2010/0320816, 2007/0132266, and 2002/0171282, the entireties of which are incorporated by reference.

The seat cushion 26 is substantially horizontal and configured to support a vehicle occupant. The seat cushion 26, and hence the seat 22 itself, may be slidable along tracks 23 affixed to the vehicle floor. The seat back 24 may comprise a substantially vertical back support portion 27 which supports the back of the vehicle occupant and a head restraint 25 which may support the head of the vehicle occupant. The back support portion 27 may be adjustable relative to the seat cushion 26 via a reclining mechanism. The head restraint 25 may be adjustable relative to the back support portion 27 such that the head restraint 25 may extend outward from the back support portion 27 or retract inward into the back support portion 27. Alternatively, the head restraint 25 may be integral to the back support portion 27 or may be omitted from the seat back 24.

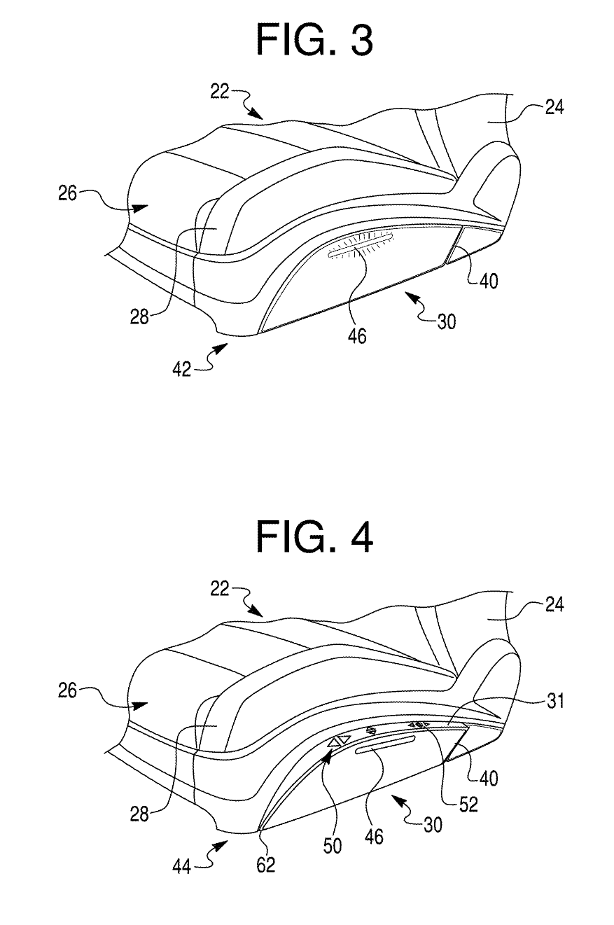

FIGS. 3 and 4 depict one embodiment of the present invention, in which a seat control interface mechanism 30 may be deployed and displayed along a side bolster region 28 of the base seat cushion 26 of the vehicle seat 22. The seat control interface mechanism 30 may be located on the inboard side or the outboard side of the vehicle seat 22.

The seat control interface mechanism 30 includes at least a movable member 40 and an interface control surface 50 located on the movable member 40 (as shown in FIG. 4). The movable member 40 is configured to be displaced relative to the seat, so that the controls are more readily accessible. For example, the movable member 40 may move, rotate, or fold out between first position 42 in which the interface control surface 50 is positioned parallel or substantially parallel to the base seat cushion 26 and a second position 44 in which the interface control surface 50 is exposed to the exterior of the vehicle seat 22 into the interior of the vehicle 20.

The seat control interface mechanism 30 may comprise a panel 31 that runs perpendicular or substantially perpendicular to the side panel 63 and/or the rear panel 65 of the movable member 40. The seat control interface mechanism 30 may also include seat controls to activate seat motors and adjustment mechanisms. For example, at least one seat control, such as at least one touch-sensitive interface or control 52, may be located on the interface control surface 50 (as shown, for example, in FIG. 6).

For example, FIG. 4 shows the interface control surface 50, which may comprise at least one touch-sensitive control 52 or manual controls. The touch-sensitive controls 52 may be used to activate, move, or adjust at least one component of the vehicle seat 22. For example, the touch-sensitive controls 52 may be configured to trigger a reclining mechanism, a forward-rearward seat sliding mechanism, a seat height adjustment mechanism, a bolster adjustment mechanism, a headrest mechanism, a height extension mechanism, and/or a lumbar adjustment mechanism. For example, the seat back 24 and the base seat cushion 26 may be adjusted relative to each other or the vehicle seat 22 may be adjusted relative to the vehicle 20, thereby accommodating occupants of different sizes. The pivoting or translational mechanisms in the reclining mechanism, the forward-rearward seat sliding mechanism, the seat height adjustment mechanism, the bolster adjustment mechanism, the headrest mechanism, the height extension mechanism, and/or the lumbar adjustment mechanism with their motors and movable elements are known in the art.

Alternatively or additionally, the seat control interface mechanism 30 may be used to control a variety of devices or mechanisms within the vehicle 20, including but not limited to climate control systems, an audio system, or a navigational system. The interface control surface 50 may include additional or alternative buttons or touch-sensitive switches (e.g. capacitive switches, touch-sensitive switches, force resistive switches) to control the various features or devices within the vehicle 20. For example, the seat control interface mechanism 30 may control a variety of devices that may be user controlled to suit the user's comfort preferences. More specifically, the seat control interface mechanism 30 may be used to control the general climate or temperature of the vehicle 20 and/or the seat climate of the vehicle seat 22. The seat control interface mechanism 30 may control devices including, but not limited to, heater mats, active cooling systems, ventilation systems, and/or fans or peltier devices, which may be integrated into the vehicle seat 22 or another area within the vehicle 20.

The touch-sensitive interface or control 52 may be, for example, an interface that does not require mechanical interaction from the user to control a system or mechanical movement within the touch-sensitive interface or control 52 may not be required. For example, the touch-sensitive interface may be activated, respond, or react when a user's finger is near or lightly touching the surface of the touch-sensitive interface. The touch-sensitive interface may use a variety of technologies, including but not limited to field-effect switching and/or a capacitive interface. The touch-sensitive interface may be a flat or smooth surface Alternatively or additionally, the surface may include at least a raised portion to provide tactile feedback to the user and may further provide haptic feedback to the user if desired.

The seat control interface mechanism 30, and, more specifically, the touch-sensitive controls 52, may utilize a variety of different technologies, including, but not limited to capacitive control, field-effect switches, piezoelectric control, and piezoresistive control. Additionally, the seat control interface mechanism 30 and the interface control surface 50 (more specifically, the touch-sensitive controls 52 and the tap bar 46), may provide haptic feedback to a user. For example, the control may vibrate when activated to give the user feedback and tactile confirmation that the control has been activated. Further, the components of the seat control interface mechanism 30, like the interface control surface 50 and the tap bar 46, may be optionally backlit with LEDs or a lightpipe beneath the interface control surface 50 or covered by an overshield in order to improve the visibility of the controls. The lighting of the backlights may optionally correspond with the interior lighting of the vehicle 20. Additionally or alternatively, the color of the backlight may change when the control is activated to provide visual confirmation of the activation, along with the tactile confirmation of the haptic feedback. An opaque or clear overshield may be located on the interface control surface 50 to protect the surface while allowing light to shine through.

The interface control surface 50 may be smooth surface or display. Alternatively, the interface control surface 50 may be a raised surface with physical buttons. For instance, the controls or buttons may be raised with oil pockets.

The interface control surface 50 may be located on the movable member 40 to allow the interface control surface 50 to be visible to or hidden from the user and/or to position the interface control surface 50 more conveniently to the user. The movable member 40 may move with respect any component of the vehicle seat 22 or with respect to any component within the vehicle 20.

The interface control surface 50 may be attached to the movable member 40 through a variety of different mechanisms. For example, the interface control surface 50 may be attached to the movable member by any suitable fastening mechanism, such as screws, adhesive, epoxy, welding, or any other suitable mechanism. Alternatively, the interface control surface 50 may be formed integrally with the movable member 40, by using, for example, injection molding or another form of molding process. The interface control surface 50 may be perpendicular or substantially perpendicular to the movable member 40, as seen in FIG. 6.

The interface control surface 50 may be partially or entirely concealed within the vehicle seat 22 when the movable member 40 is retracted toward the vehicle seat 22 into the first position 42 and may partially or entirely exposed when the movable member 40 is extended away from the vehicle seat 22 into the second position 44.

The moveable member 40 may be in a variety of different configurations and may use a variety of different technologies in order to move and to be concealed or visible. For example, the movable member 40 may be a panel that is connected to a hinge mechanism 60 to rotate or pivot about a pivot axis 62 between the first position 42 and the second position 44, as shown, for example, in FIGS. 4 and 6. The panel may be a flat, substantially flat, or curved. In the first position, the panel extends in a vertical or substantially vertical direction. In the second position, the panel extends at a non-zero angle from the first position. For example, the angle may be between about 5 to about 90 degrees, preferably about 5 to about 45 degrees, more preferably about 5 to about 25 degrees. The panel may be made of any suitable material, such as, for example, plastic or metal. As seen in FIG. 6, the movable member may comprise a side panel 63 and a rear panel 65 that is approximately perpendicular to the side panel 63.

FIG. 3 shows the seat control interface mechanism 30 in the first position 42, in which the movable member 40 is at least partially retracted toward the vehicle seat 22 such that the seat control interface mechanism 30 is concealed inside the vehicle seat 22. The interface control surface 50 may be completely hidden and not visible in the first position 42 in order to provide a seamless appearance for the contours of the vehicle 20.

FIG. 4 shows the seat control interface mechanism 30 in the second position 44, in which the movable member 40 is extended at least partially out of the vehicle seat 22. The interface control surface 50 may be at least partially, or entirely, visible to the occupant and may be positioned parallel or substantially parallel to the base seat cushion 26 of the vehicle seat 22.

In the first position 42, the movable member 40 may be located inside the side bolster region 28, on the inboard side or the outboard side of the vehicle seat 22. The movable member 40 may include a tap bar 46 to activate the movement of the movable member 40 between the first position 42 and the second position 44. The tap bar 46 may utilize a variety of different mechanisms to activate the movement of the movable member 40 between the first position 42 and the second position 44. For example, the tap bar 46 may be a touch-sensitive button and/or a lever that operates a spring loaded latch that is triggered to pop the movable member 40 out upon depression so as to rotate about the hinge mechanism 60. Alternatively, the touch-sensitive button and/or lever may operate a motor so that the movable member 40 rotates about the hinge mechanism 60. In the second position 44, the movable member 40 may be located along or near various components of the vehicle seat 22.

To move the movable member 40 back into the first position 42, for example, the touch-sensitive button and/or lever may operate the motor so as to reverse the rotation about the hinge mechanism 60. Alternatively, the movable member 40 may simply be pushed back against the force of the spring by the user so as to close the spring-loaded latch such that the latch may be re-engaged when the tap bar 46 is moved back into the first position 42. The tap bar 46 may optionally be backlit to increase visibility or have a raised, lowered, or textured surface in order to provide tactile feedback.

According to one embodiment, instead of using the hinge mechanism 60, the movable member 40 may be slide in a linear direction into and out of the seat 22 in a spring loaded manner along tracks. According to other embodiments, the movable member may move by sliding, pivoting, or any combination thereof. In the sliding embodiment, the movable member 40 may comprise the side panel 63, the rear panel 65, and a front panel (that is parallel or substantially parallel to the rear panel) in which the interface control surface 50 rests perpendicularly or substantially perpendicularly on top of the three panels.

According to one embodiment, as shown in FIG. 6, the movable member 40 may move between the first position 42 and the second position 44 in a vertical or longitudinal direction and/or a horizontal or lateral direction (as indicated by the arrows). The interface control surface 50 may be displayed at a near parallel plane to the base seat cushion 26 and may include a curvature. This configuration may increase the accessibility and visibility of the interface control surface 50 when in the second position 44 and completely conceal the seat control interface mechanism 30 when not in use in the first position 42 for a seamless appearance.

FIG. 6 shows one type of hinge mechanism 60 that may be used to move the movable member 40 between the first position 42 and the second position 44 in order to display or conceal the interface control surface 50. The hinge mechanism 60 may be integrated with the tap bar 46. The hinge mechanism 60 may utilize a variety of different mechanisms, including, but not limited to mechanical, motorized, electrical, door latch system, assisted spring, or spring loaded. Alternatively, the movable member 40 may utilize one or more arms (for example, the rear panel 65) so as to protect the wiring leading to the one or more touch-sensitive controls 52 when moving between the first position 42 and the second position 44.

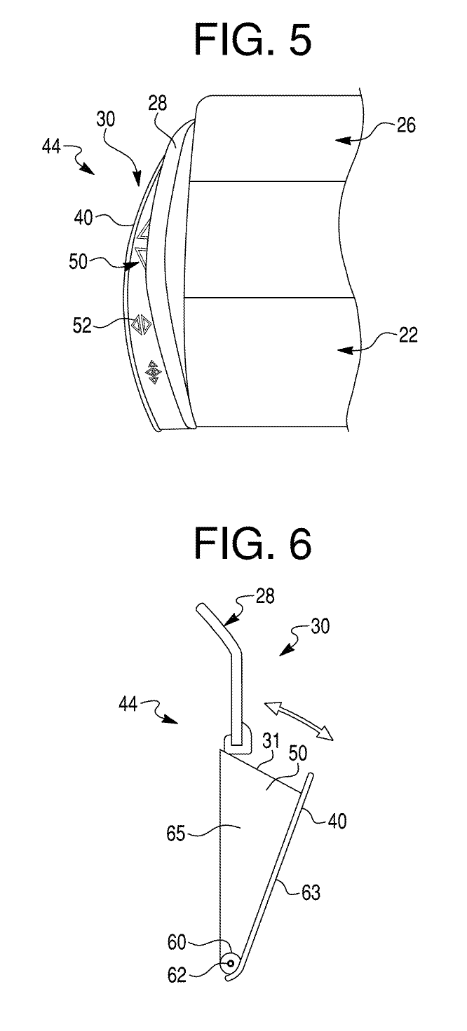

FIG. 5 shows the seat control interface mechanism 30 in the second position 44 from the view of the occupant in the vehicle seat 22. The interface control surface 50 may include a variety of different types of controls, symbols, labels, and indicators. For example, FIG. 5 shows arrows pointing forward and backward to indicate moving the vehicle seat 22 forward and rearward within the vehicle 20 to accommodate occupants of different sizes. The labels or pictograms corresponding to the buttons or touch-sensitive controls 52 may be located above the buttons or controls to allow the user to see the labels while the buttons or controls are depressed or activated. Alternatively or additionally, the seat controls may include one or more of the following controls: push buttons, knobs, sliding buttons, joysticks, flip switches, touch screens, or any combination thereof.

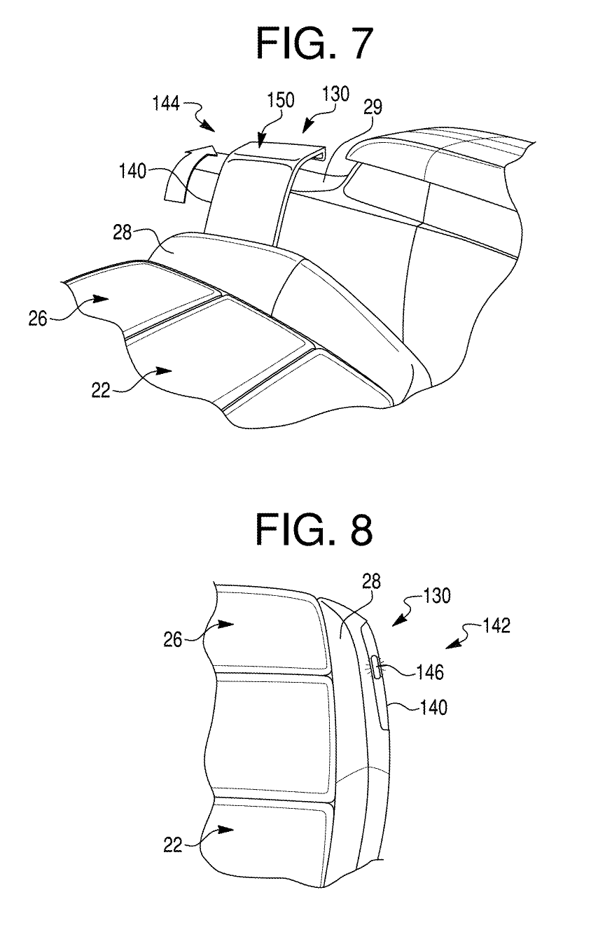

According to another embodiment, as shown in FIGS. 7-10, the seat control interface mechanism 130 may be located on the inboard side bolster region 28 of the vehicle seat 22 and may move into a second position 144, in which the interface control surface 150 may hang over a center console 29.

The seat control interface mechanism 130 is like the seat control interface mechanism 30. A movable member 140 of this embodiment is an extended arm-like structure or panel that is made of a material such as plastic or metal. As in the above embodiments, an interface control surface 150, similar to the interface control surface 50, may be attached to the movable member 140 by any suitable fastening mechanism, such as screws, adhesive, epoxy, welding, or any other suitable mechanism. Alternatively, the interface control surface 150 may be formed integrally with the movable member 140, such as using an injection molding or other form of molding process. The interface control surface 150 may be perpendicular or substantially perpendicular to the movable member 140, as seen in FIG. 7.

When the seat control interface mechanism 130 is in a first position 142, it may be stowed and concealed between the side bolster region 28 on the inboard side of the vehicle seat 22 and the console 29. The interface control surface 150 may optionally be at least partially flexible. The seat control interface mechanism 130 may be configured to have a space beneath the interface control surface 150 for a user to put their fingers under while touching the interface control surface 150.

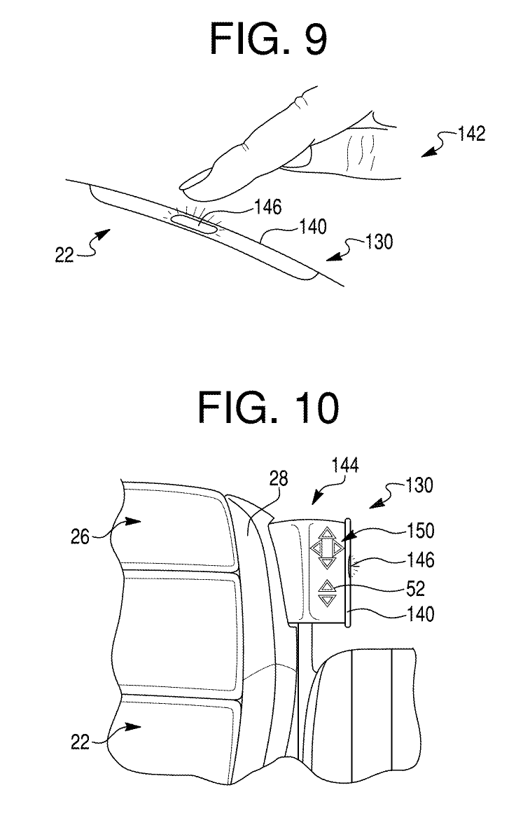

FIGS. 8 and 9 show the seat control interface mechanism 130 in the first position 142. By activating or touching a tap bar 146 (as shown in FIG. 9), the movable member 140 may move or slide into the second position 144 to reveal the interface control surface 150, as shown in FIG. 10. Conversely, the tap bar 146 may be used to retract the movable member 140 back into the first position 142 to conceal the interface control surface 150. According to one embodiment, the movable member 140 may extend away from the vehicle seat 22 by a spring loaded latch. In this case, to move the movable member 140 back into the first position 142, the seat control interface mechanism 130 may be manually pushed down against the force of the spring until the latch catches so as to retract toward the vehicle seat 22. According to another embodiment, the movable member 140 may be retracted and extended by a retracting mechanism, which may be a DC motor with a geared arrangement, such as, for example, a rack and pinion arrangement. In this case, to move the movable member 140 back into the first position 142, the seat control interface mechanism 130 may a button on the interface control surface 150 may be used to activate the retracting mechanism.

The ability of the seat control interface mechanism 30 and 130 to retract into the first position 42 or 142 may minimize the packaging requirements of the vehicle seat 22. Additionally, there is no longer a space requirement between the vehicle door and the outboard side bolster region 28 of the vehicle seat 22 so as to allow enough room for a large hand to reach the seat controls. Further, the interface control surface 50 and 150 may be completely visible to the occupant when in the second position 44 or 144 inside the vehicle seat 22. Therefore, the stow-away ability of the seat control interface mechanism 30 and 130 may allow for more room within the vehicle 20, allow the vehicle 20 to be smaller, and/or allow the vehicle seat 22 to be wider and more comfortable for the occupant. Additionally, the visual and haptic feedback from the seat control interface mechanism 30 and 130 may improve the human-machine interface of the seat controls.

According to another embodiment, the seat control interface mechanism 30 may include automatic or manual methods to conceal or retract the seat control interface mechanism 30 into the first position 42 in order to, for example, protect the mechanics or physical features of the seat control interface mechanism 30 or to prevent the controls from inadvertently being activated or pushed. For example, the seat control interface mechanism 30 may include a timer configured to automatically retract the seat control interface mechanism 30 into the first position 42 after a certain amount of time after the last command was executed. The seat control interface mechanism 30 may further include a button, lock, feature, or control to prevent the seat control interface mechanism 30 from being automatically retracted. The seat control interface mechanism 30 may additionally be configured to automatically extend or open into the second position 44 after, for example, the vehicle 20 has been unlocked or turned on.

With any of the above embodiments, a method of operation to adjust a seat orientation of a vehicle seat may comprise moving an interface control surface from a first position inside the vehicle seat to a second exposed position outside the vehicle seat; operating at least one touch-sensitive control to activate at least one component of the vehicle seat; and/or moving the interface control surface from the second exposed position outside the vehicle seat to the first position inside the vehicle seat. The moving of the interface control surface from the first position to the second exposed position (or vice versa) may comprise using one of an electrical mechanism (such as a motor), a mechanical mechanism (such as springs, hinges, a geared system), or a combination thereof.

Because the interface control surface may be disposed on a movable member, the step of moving the interface control surface from the first position to the second exposed position may comprises move the movable member vertically and laterally from the first position to the second position and/or pivoting the movable member about a pivot axis.

As used herein, the meaning of “about,” “substantial,” “substantially,” “approximately” is generally meant to be within +/−10% of the value it modifies, for example, within +/1.0% of the value it modifies. Also used herein, the meaning of “partially” is generally meant to be greater than about 25% to less than 100% of the term it modifies, for example, greater than 50% or 75% and less than 100%.

The embodiments disclosed herein allow the seat orientation of a vehicle seat to be adjusted by a seat control interface that may be concealed or retracted when not in use. Besides those embodiments depicted in the figures and described in the above description, other embodiments of the present invention are also contemplated. For example, any single feature of one embodiment of the present invention may be used in any other embodiment of the present invention. The following is a list of embodiments, but the invention should not be viewed as being limited to these embodiments.

Given the disclosure of the present invention, one versed in the art would appreciate that there may be other embodiments and modifications within the scope and spirit of the invention. Accordingly, all modifications attainable by one versed in the art from the present invention within the scope and spirit of the present invention are to be included as further embodiments of the present invention.

What is claimed is:

1. A seat control interface mechanism for a vehicle seat, comprising:
an interface control surface having at least one interface that allows an occupant of the vehicle seat to activate seat controls; and
a movable member upon which the interface control surface is located, the moveable member being configured to be displaced relative to the vehicle seat to cause the interface control surface to become more accessible to the occupant of the vehicle seat.

2. The seat control interface mechanism according to claim 1, wherein the movable member is configured to be at least partially retracted toward the vehicle seat into a first position, wherein the interface control surface is configured to be substantially contained within the vehicle seat when the movable member is in the first position, wherein the movable member is configured to be at least partially extended away from the vehicle seat into a second position, wherein the interface control surface is configured to be substantially exposed to an interior of the vehicle when the movable member is in the second position.

3. The seat control interface mechanism according to claim 2, wherein the movable member is configured to be deployed away from a side bolster of the vehicle seat such that the interface control surface is positioned substantially parallel to a seat cushion of the vehicle seat.

4. The seat control interface mechanism according to claim 1, wherein the interface control surface comprises at least one touch-sensitive interface.

5. The seat control interface mechanism according to claim 4, wherein the at least one touch-sensitive interface is configured to activate at least one of a reclining mechanism, a forward-rearward seat sliding mechanism, a seat height adjustment mechanism, a bolster adjustment mechanism, and a lumbar adjustment mechanism.

6. The seat control interface mechanism according to claim 4, wherein the at least one touch-sensitive interface is one of a capacitive control, a piezoelectric control, and a piezoresistive control.

7. The seat control interface mechanism according to claim 4, wherein the at least one touch-sensitive interface is configured to provide haptic feedback to the occupant of the vehicle seat.

8. The seat control interface mechanism according to claim 1, wherein the interface control surface comprises at least one backlit interface.

9. The seat control interface mechanism according to claim 2, wherein the movable member is rotatable between the first position in which the interface control surface is entirely inside a side bolster of the vehicle seat and the second position in which the interface control surface is between the side bolster and a vehicle door.

10. The seat control interface mechanism according to claim 1, wherein the movable member is movable between a first position and a second position.

11. The seat control interface mechanism according to claim 1, wherein the movable member is configured to move vertically and laterally from a first position to a second position.

12. A method of adjusting an orientation of a vehicle seat, comprising:
moving an interface control surface relative to the vehicle seat to cause the interface control surface to become more accessible to an occupant of the vehicle seat; and
operating at least one touch-sensitive interface on the interface control surface to activate at least one seat control for the vehicle seat.

13. The method of claim 12, wherein the step of moving the interface control surface includes moving the interface control surface from a first position in which the interface control surface is substantially contained within the vehicle seat to a second position in which the interface control surface is substantially exposed to the interior of the vehicle.

14. The method according to claim 12, wherein the interface control surface is disposed on a movable member, and wherein moving the interface control surface from a first position to a second position comprises moving the movable member vertically and laterally from the first position to the second position.

15. The method according to claim 12, wherein the interface control surface is disposed on a movable member, and wherein moving the interface control surface from the first position to the second exposed position comprises pivoting the movable member about a pivot axis.
